(19) United States
(12) Patent Application Publication
(10) Pub. No.: US 2015/0086200 A1
(43) Pub. Date: Mar. 26, 2015

(54) Space To Wavelength Superchannel Conversion

(71) Applicant: Alcatel-Lucent USA Inc., Murray Hill, NJ (US)

(72) Inventors: Chongjin Xie, Morganville, NJ (US); Roland Ryf, Aberdeen, NJ (US)

(73) Assignee: Alcatel-Lucent USA Inc., Murray Hill, NJ (US)

(21) Appl. No.: 14/032,930

(22) Filed: Sep. 20, 2013

(51) Int. Cl. H04B 10/2581

(52) U.S. Cl. CPC H04B 10/2581
USPC 398/44

(57) ABSTRACT

An apparatus inputs an input configured to receive an input optical signal, and an output configured to output an output optical signal. A superchannel converter is coupled between the input and the output. The superchannel converter is configured to convert N spatial modes of the input optical signal to M spatial modes of the output optical signal.

### TECHNICAL FIELD

The disclosure relates generally to the field of optical communications.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Optical communications systems are approaching the capacity limits imposed by single mode optical fibers. To increase the capacity of optical networks to meet expected increases of traffic demand, space division multiplexing (SDM) may be used with optical fibers having multiple spatial propagation modes. Such optical fibers include multi-mode fibers (MMF) and multi-core fibers (MCF). Increasing attention has been directed to development of multiple spatial mode fibers (both MMF and MCF), resulting in significant progress on fundamental issues of SDM transmission. For example, transmission capacity using SDM has been demonstrated having a factor of ten improvement compared with single mode fibers (SMFs).

### SUMMARY

One embodiment provides an apparatus, e.g. configured to convert spatial modes of an input superchannel to spatial modes of an input superchannel. The apparatus has an input configured to receive an input optical signal and an output configured to output an output optical signal. A superchannel converter is configured to convert N spatial modes of the input optical signal to M spatial modes of the output optical signal.

In any embodiment of the apparatus the superchannel converter may be configured to convert an N-mode space superchannel to a wavelength superchannel that includes a corresponding plurality of wavelength channels. In any embodiment the superchannel converter may be configured to convert an N-mode space superchannel to an M-mode space/wavelength superchannel, with at least one mode of the M-mode space/wavelength superchannel including a plurality of wavelength channels. In any of the above embodiments the wavelengths of the converted space/wavelength superchannel may be mode-locked.

Another embodiment provides a method, e.g. for forming a superchannel converter. The method includes configuring a superchannel converter to receive an input superchannel having N spatial modes and to output at least one output superchannel having M spatial modes. The method further includes configuring the superchannel converter to convert the N spatial modes of the input superchannel to the M spatial modes of the at least one output superchannel.

In any embodiment the superchannel converter may be configured to perform optical-electrical-optical conversion of the input optical signal to the output optical signal. In any such embodiment the superchannel converter may be further configured to frequency-shift a quadrature signal.

In any embodiment the superchannel converter may be configured to optically shift each of a plurality of the N spatial modes of the input optical signal from an input frequency to a corresponding output frequency. In any such embodiment the optical frequency shift may be performed by four-wave mixing (FWM) or parametric amplification.

In any embodiment the superchannel converter may further be configured to convert a plurality of wavelength channels of a spatial superchannel to a wavelength superchannel. In such embodiments the wavelength channels may have different center wavelengths. In any embodiment the apparatus may further include an input optical waveguide coupled to the input and an output optical waveguide coupled to the output.

### BRIEF DESCRIPTION OF THE DRAWINGS

A more complete understanding of the present invention may be obtained by reference to the following detailed description when taken in conjunction with the accompanying drawings, wherein:

FIG. 1 illustrates an embodiment, e.g. of a system, detailing inter-connection of a multimode fiber (MMF), multi-core fiber (MCF) and a single-mode fiber (SMF) via a space and wavelength switch;

FIG. 2 illustrates an embodiment of a space/wavelength superchannel converter coupled to an input fiber with N spatial modes and an output fiber with M spatial modes;

FIG. 3 illustrates schematically the conversion of a space superchannel with N spatial modes to a wavelength superchannel with a single spatial mode (M=1);

FIG. 4 illustrates schematically the conversion of a space superchannel with N spatial modes to a space and wavelength superchannel with M modes (M>1 and M<N);

FIG. 5A illustrates an embodiment of a space superchannel to wavelength superchannel convertor based on an optical-electrical-optical structure (OEO), with individual lasers providing source light for some frequency channels;

FIG. 5B illustrates an embodiment of a single optical to electrical convertor (O/E), such as may be used in the embodiment of FIG. 5A;

FIG. 5C illustrates an embodiment of the convertor of FIG. 5A, in which a comb generator provides source light for some frequency channels such that the frequency channels are mode-locked;

FIG. 6A illustrates a space superchannel to wavelength superchannel convertor that uses wavelength shifters;

FIG. 6B illustrates a single wavelength shifter based on I/Q modulators, such as may be used in the embodiment of FIG. 6A;

FIG. 6C illustrates a single wavelength shifter such as may be used in the embodiment of FIG. 6A, wherein the wavelength shifter is based on four wave mixing (FWM) or parametric amplification;

FIG. 7A illustrates an embodiment of space superchannel conversion to a wavelength superchannel with a single spatial mode (M=1), such as may be implemented by the embodiment of FIG. 8A, wherein each input spatial mode is assigned a different center wavelength;

FIG. 7B illustrates an embodiment of space superchannel conversion to a combined space-wavelength superchannel, such as may be implemented by the embodiment of FIG. 8B;

FIG. 8A illustrates space superchannel to wavelength superchannel conversion using the wavelength/spatial plan shown in FIG. 7A; and

FIG. 8B illustrates an embodiment of space superchannel to wavelength superchannel conversion using the plan of FIG. 7B, in which a frequency shift may be applied to a group of wavelength channels.

### DETAILED DESCRIPTION

The disclosure is directed to, e.g. methods and systems for converting superchannels of a first (e.g. input) optical communication signal propagating on a first fiber to different superchannels of a second (e.g. output) optical communication signal propagating on a second fiber.

Deployment of SDM transmission in existing optical networks will in many cases necessarily include integrating spatial mode fibers and single mode fibers in the system. For example, mixed systems may integrate multi-core and/or multi-mode fibers with single-mode fibers, or multi-core fibers and/or multi-mode fibers with other multi-core fibers and/or multi-mode fibers having different numbers of cores/modes.

Embodiments described herein and otherwise within the scope of the disclosure and the claims reflect the recognition that novel switching devices and methods will be needed to implement spatial mode-diverse optical transmission systems. Furthermore embodiments reflect the further recognition that when such devices and methods include the ability to remap frequency channels among superchannels, routing of signals in a spatial mode-diverse optical network is advantageously simplified.

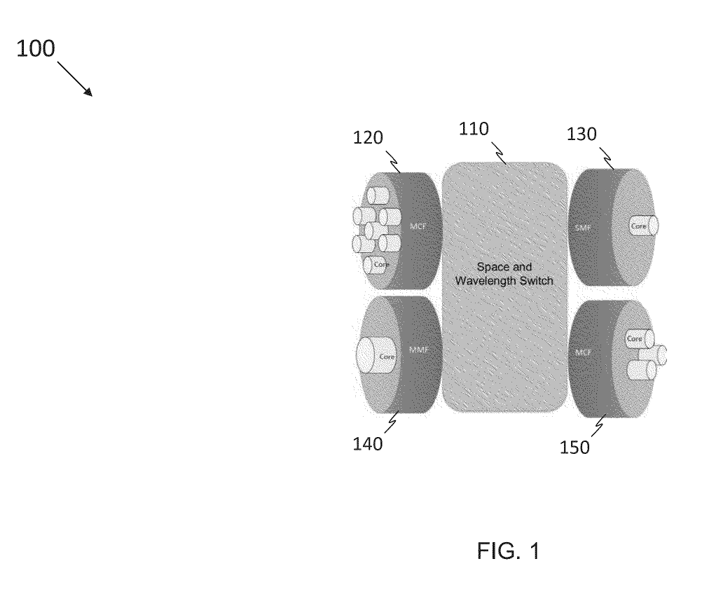

FIG. 1 illustrates an embodiment, e.g. of a network 100, detailing inter-connection between several optical fibers via a space and wavelength switch (SWS) 110. The SWS 110 provides interconnection between a first MCF 120, an MMF 130, an SMF 140 and a second MCF 150. In the illustrated embodiment the number of modes of the MMF 130, e.g. >1, is different from the number of mode of the SMF 140. Moreover, the number of cores of the MCF 130, e.g. seven, is different from the number of cores of the MCF 150, e.g. three.

Transmission via a MCF or a MMF may include the use of one or more space superchannels. As used herein, a “space superchannel” includes a number of sub-channels, wherein sub-channels of the space superchannel may have a same wavelength and may additionally occupy a same bandwidth. When inter-connecting multi-core fibers having a different number of cores, multi-mode fibers having a different number of modes, or a multi-core fiber or multi-mode fiber to a single-mode fiber, one technical issue is the conversion of superchannels of one fiber to other fibers, for example converting space superchannels of a MMF/MCF to a SMF. Embodiments described herein and otherwise consistent with the description provide various solutions to these technical challenges.

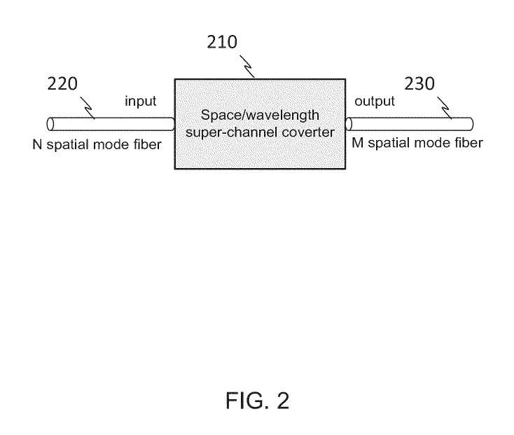

In some embodiments, described further below, and illustrated at a high level in FIG. 2, a function module, e.g. a superchannel converter 210, switches a superchannel from one propagation type to another propagation type to interface a fiber 220 to a fiber 230. For example, the converter 210 may receive N spatial modes from the fiber 220, and convert the N spatial modes to M spatial modes on the fiber 230. In another example, the converter 210 may receive N spatial modes from the fiber 220, and convert the N spatial modes to M frequency channels on the fiber 230. In another example, the converter 210 may convert the N received spatial modes to M spatial modes, each having one or more frequency channels propagating thereon. Those skilled in the pertinent art will appreciate that these examples are not exhaustive of the possible conversions performed by the converter 210. It is noted that the conversion performed by the converted 210 may not be needed when N≦M.

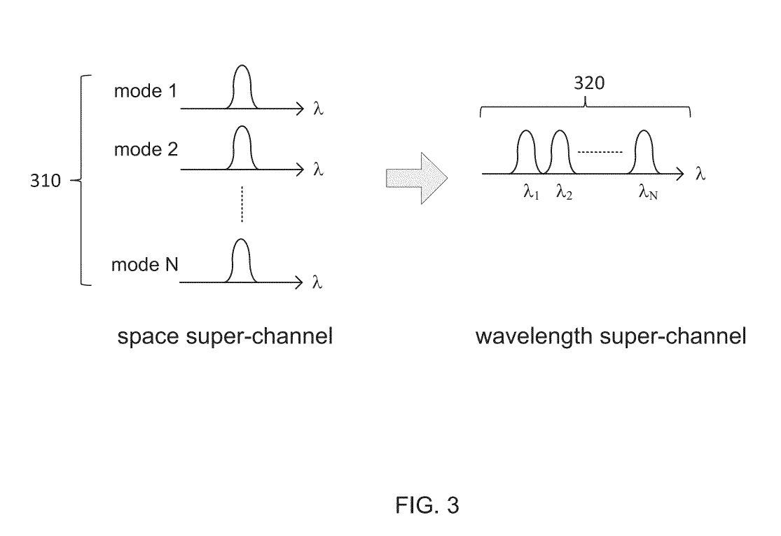

FIG. 3 illustrates schematically the conversion of a space superchannel 310 with N modes to a wavelength superchannel 320 with N wavelengths, with M equal to one. A received signal has N modes, each of which may propagate a signal modulated independently of the other modes. The center wavelength of each of the N received signals may be about equal to each other. Each of the N received signals is transferred, e.g. by the converter 210, to one of N output signals at corresponding signals having non-overlapping center wavelengths, e.g. λ₁, λ₂ . . . λ_{N}. By “non-overlapping” it is meant that the center wavelengths of the N output signals are not about equal, e.g. such that the spectral peaks intensity of each of the output signals may be clearly resolved. The N output signals may be combined to a wavelength-division multiplexed (WDM) signal propagating on a single propagation mode. As used herein, the group of N signals propagating via different modes is referred to as a space superchannel. As used herein, a “wavelength superchannel” refers to a group of N signals propagating via different frequencies on a single propagating mode. A “space/wavelength superchannel” is a signal having characteristics of both a space superchannel and a wavelength superchannel, e.g. channel signals propagating by multiple spatial modes and multiple frequencies.

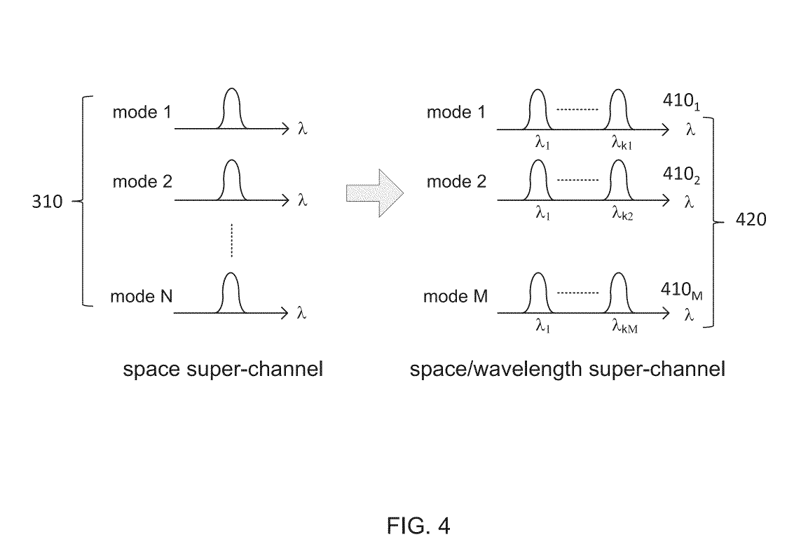

FIG. 4 illustrates schematically the conversion of the space superchannel 310 with N modes to M wavelength superchannels 410₁, 410₂ . . . 410_{M}, e.g. by the converter 210. The set of M wavelength superchannels is denoted space/wavelength superchannel 420. Each of the M wavelength superchannels 410 occupies a single spatial mode and has a number of multiplexed wavelength channels k₁, k₂ . . . k_{M} such that k₁+k₂+ . . . +k_{M}=N. Thus the N signals received at the converter 210 via the N propagation modes are distributed among the M propagation modes of the converted optical signal.

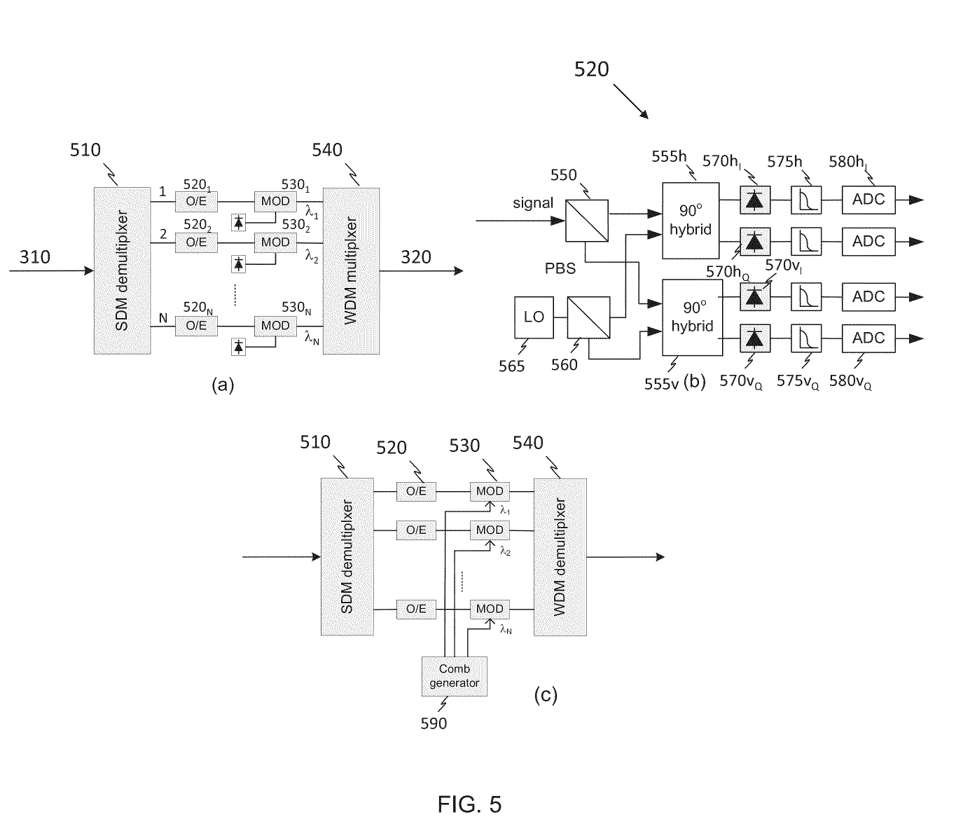

FIGS. 5A/B and 6A/B illustrate embodiments that may be used to implement portions of the converter 210. While these embodiments provide specific examples of implementation of the converter 210, those skilled in the optical arts will appreciate that there are numerous alternative embodiments that may provide substantially similar functionality. Such embodiments are expressly included in the scope of the description and claims. Moreover, while the embodiments in FIGS. 5A/B and 6A/B are described for embodiments in which M=1, those skilled in the pertinent art can easily extend the described principles to embodiments in which M>1.

The embodiment of FIG. 5A illustrates, without limitation, use of an optical-electrical-optical (OEO) technique for converting N spatial modes to a wavelength superchannel. A spatial mode demultiplexer 510 receives an optical signal that includes a space superchannel, e.g. a plurality of signals propagating via different orthogonal spatial modes, such as the space superchannel 310 (FIG. 3). The space superchannel 310 may be received, e.g. from a multi-mode optical fiber or a multi-core optical fiber. The demultiplexer 510 may be implemented in any conventional or future discovered manner. One nonlimiting example of the demultiplexer 510 is provided by the M3 Modal MUX/DEMUX, available from Kylia, Paris, France, www.kylia.com/Kylia.modal.mux.pdf, incorporated herein by reference.

The demultiplexer 510, e.g. an SDM demultiplexer, separates the N spatial modes and provides these at N corresponding outputs. Each output provides the corresponding spatial mode signal to a corresponding optical/electrical (O/E) converter 520₁, 520₂ . . . 520_{N}. Each of modulators 530₁, 530₂ . . . 530_{N}, e.g. Mach-Zehnder modulators, receives the electrical-domain output of a corresponding one of the O/E converters 520₁, 520₂ . . . 520_{N}, and modulates the output of a corresponding unreferenced laser source. The laser sources may have wavelengths λ₁, λ₂ . . . λ_{N}. The modulators 530₁, 530₂ . . . 530_{N} thereby produce N modulated signals with center wavelengths λ₁, λ₂ . . . λ_{N}. A multiplexer 540, e.g. a WDM multiplexer, receives the outputs of the modulators 530₁, 530₂ . . . 530_{N}, and produces a combined output, e.g. a WDM signal, exemplified by wavelength superchannel 320 of FIG. 3.

FIG. 5B illustrates a nonlimiting embodiment of one instance of the O/E converter 520. The illustrated embodiment assumes without limitation thereto that the signals output at the outputs of the demultiplexer 510 are polarization multiplexed, e.g. with horizontal (H) and vertical (V) components. A polarization beam splitter (PBS) 550 receives the corresponding output of the demultiplexer 510 and separates the H and V polarizations. Ninety degree optical hybrids 555h, 555v respectively receive the H and V components of the received signal from the PBS 550. A second PBS 560 receives the output of a local oscillator (LO) 565, and provides H and V components thereof respectively to the optical hybrids 555h, 555V. Detectors 570h_{I} and 570h_{Q} respectively convert I and Q outputs of the optical hybrid 555h to analog-electrical signals, which are filtered by filters 575h and converted to digital-electrical signals by analog-to-digital converters (ADCs) 580h. Similarly, detectors 570v_{I} and 570v_{Q} respectively convert I and Q outputs of the optical hybrid 555v to analog-electrical signals, which are filtered by filters 575v and converted to digital-electrical signals by ADCs 580v. Skilled practitioners of the optical arts will recognize that the described embodiment of the O/E 520 may have numerous variants with equivalent functionality within the scope of the description and the claims.

FIG. 5C illustrates an alternate embodiment of the converter illustrated in FIG. 5A. In the embodiment of FIG. 5C, a comb generator 590 provides unmodulated outputs at λ₁, λ₂ . . . λ_{N} to corresponding ones of the modulators 530₁, 530₂ . . . 530_{N}. It is believed that if the input signal 310 received from an MMF or an MCF has crosstalk between spatial modes, it may be preferable that the λ₁, λ₂ . . . λ_{N} signals be mode-locked. The outputs of the comb generator 590 provide this feature. In this case the wavelength channels of the wavelength channels in the output of the multiplexer 540 are also mode-locked.

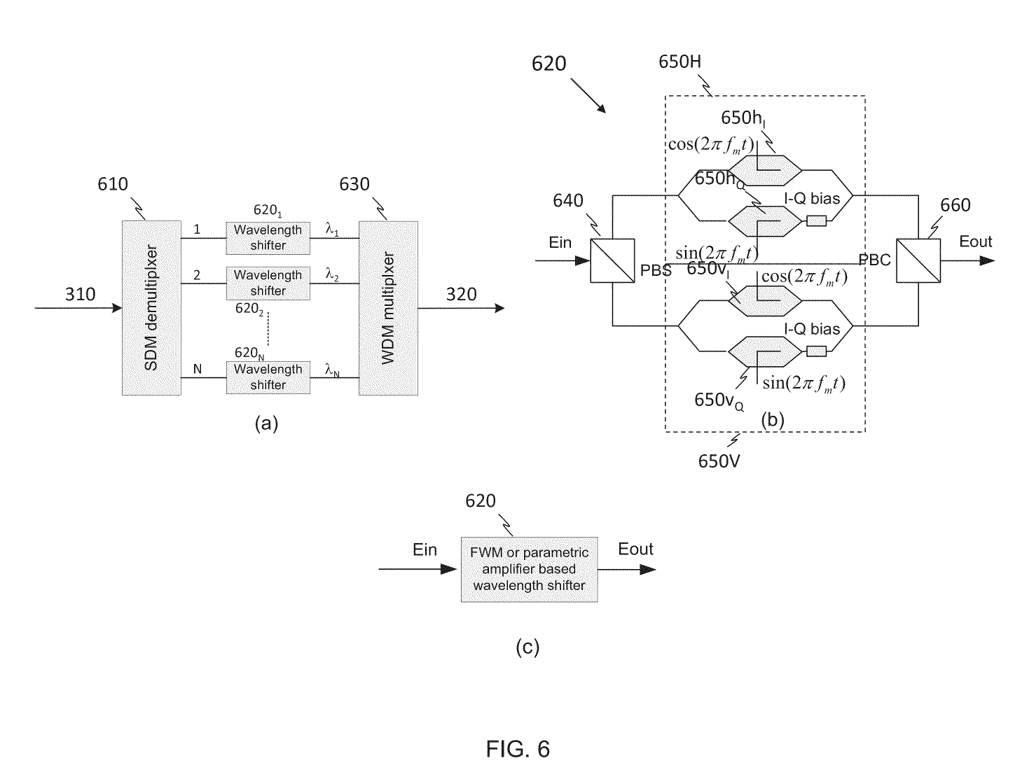

FIG. 6A illustrates another embodiment that may implement the conversion of N spatial modes to a wavelength superchannel. In this embodiment wavelength shifters are used to effect the conversion. In this embodiment, a spatial mode demultiplexer 610 receives an optical signal that includes a space superchannel, e.g. the space superchannel 310 (FIG. 3). As described previously the demultiplexer 610 separates the N spatial modes and provides these at N corresponding outputs. Each of N wavelength shifters 620₁ . . . 620_{N} receives a corresponding output of the demultiplexer 610. The wavelength shifters 620 convert signals in the N different spatial modes to wavelength sub-channels having different center wavelengths λ₁, λ₂ . . . λ_{N}. A multiplexer 630, e.g. a WDM multiplexer, combines the N wavelength sub-channels into a single WDM signal to form a wavelength superchannel, e.g. the wavelength superchannel 320.

The wavelength shifters 620 may be implemented by one of a number of techniques, one of which is illustrated in FIG. 6B based on I/Q modulation, without limitation thereto. Other techniques that may be used include, e.g., four-wave mixing based techniques, parametric amplification, and in-phase/quadrature (I/Q) modulator-based techniques.

A PBS 640 receives a signal denoted Eᵢₙ from one of the outputs of the demultiplexer 610. As before this embodiment assumes without limitation thereto that the Eᵢₙ signal is polarization multiplexed, e.g. with H and V components. The PBS 640 splits the Eᵢₙ signal into the H and V polarized components which are routed to I/Q modulators 650H and 650V. Considering the modulator 650H, the H signal component is split between an I modulator 650h_{I} and a Q modulator 650h_{Q} and recombined. The modulator 650H is driven by sinusoidal signals having frequency fₘ. An unreferenced I/Q bias may be adjusted, thereby shifting the frequency of the modulated signal up or down by kfₘ where k is unity or an integer greater than unity. The modulator 650V operated in analogous fashion. A polarization beam combiner (PBC) 660 combines the outputs of the modulators 650H and 650V to produce a signal Eₒᵤₜ with the desired wavelength to be received by the multiplexer 320.

FIG. 6C illustrates an embodiment of one instance of the wavelength shifter 620. In this embodiment the wavelength shifter 620 is based on four wave mixing (FWM) or parametric amplification. As will be appreciated by those skilled in the optical arts an input signal Eᵢₙ with one wavelength, such as from the demultiplexer 610, is wavelength shifted to another wavelength at the output Eₒᵤₜ with the use of a pump laser. As described earlier, in some embodiments the input signal 310 from an MMF or an MCF may be subject to crosstalk between spatial modes. In such cases is may be preferable that the pumps lasers of the N wavelength shifters 620₁ . . . 620_{N} be mode locked. In such embodiments the pumps may be provided by a single source such as an optical comb generator, e.g. the comb generator 590.

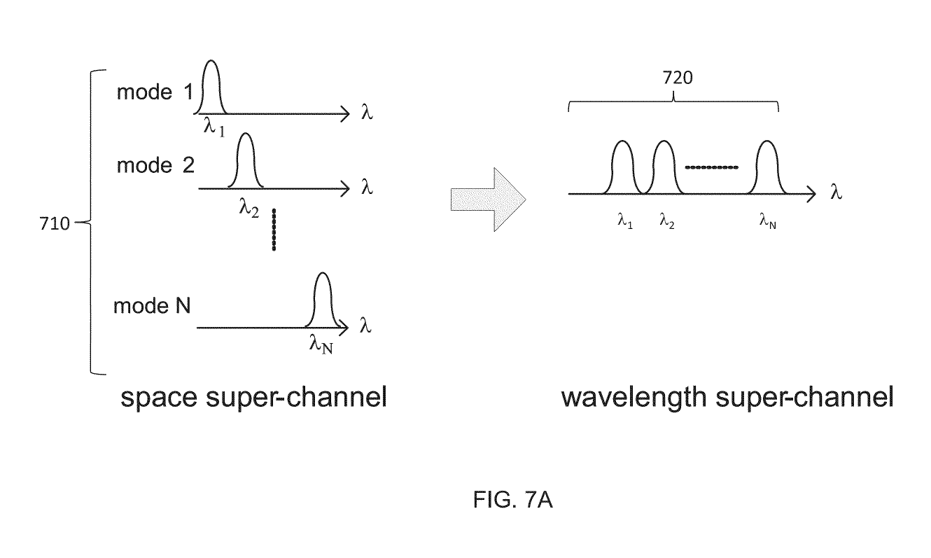

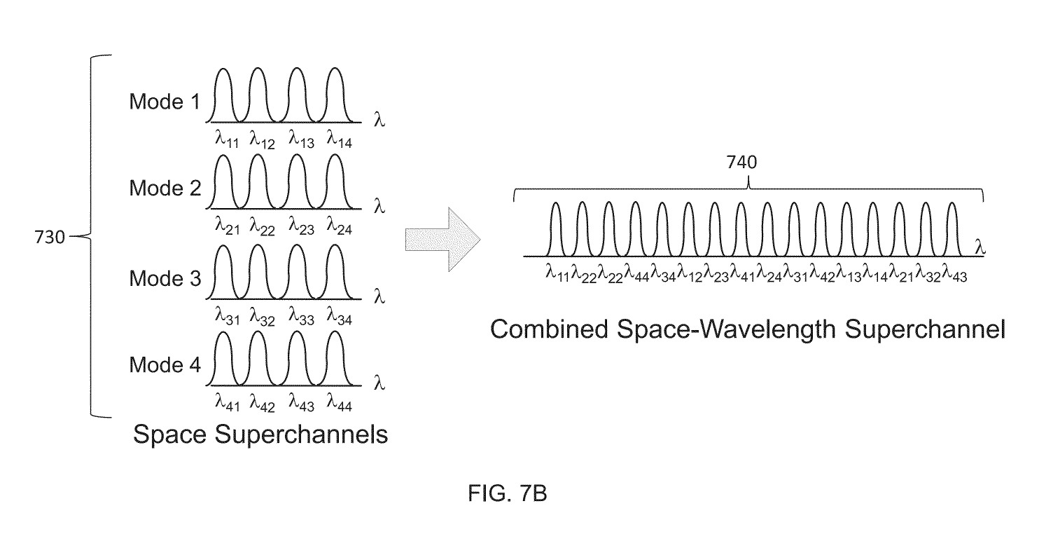

FIG. 7A illustrates aspects of an alternate embodiment in which each spatial mode of a space superchannel may be associated with a different wavelength. In the illustrated embodiment a space superchannel 710 that includes N spatial modes each having a different wavelength λ₁, λ₂ . . . λ_{N} is converted to a wavelength superchannel 720. Such embodiments may provide an advantage over some other embodiments in that the space superchannels can be transformed into wavelength superchannels without the need of a wavelength shifter.

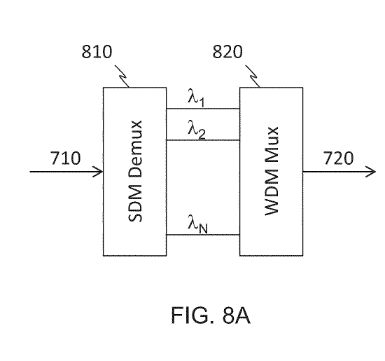

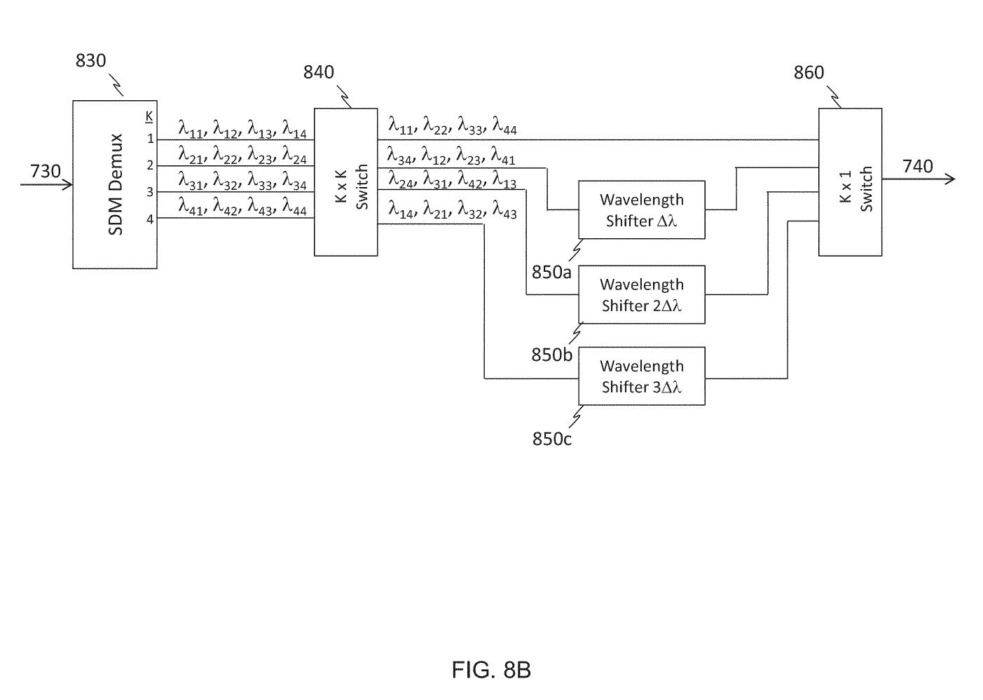

FIG. 8A illustrates an embodiment that may implement the superchannel conversion illustrated in FIG. 7A. In FIG. 8A a spatial demultiplexer 810 is coupled to a WDM multiplexer 820. The spatial demultiplexer 810 receives an input signal, e.g. the space superchannel 710, and outputs N signals corresponding to each of the wavelength sub-channels λ₁, λ₂ . . . λ_{N} of the input signal. The WDM multiplexer 820 then combines the separate wavelength sub-channels into a single wavelength superchannel, e.g. the wavelength superchannel 720.

FIG. 7B illustrates aspects of an alternate embodiment in which a space superchannel 730 includes K spatial propagation modes (K=4), each mode having N wavelength channels (N=4), wavelength channels being designated λ_{KN}. The space superchannel is converted to a combined space-wavelength superchannel 740, in which the wavelength channels are reordered. Such a conversion may be implemented using, e.g. the embodiment illustrated in FIG. 8B.

FIG. 8B illustrates an embodiment of conversion of K space superchannels each having N wavelength channels to a combined space-wavelength superchannel. The embodiment of FIG. 8B is illustrated without limitation for the case that K=N=4.

An SDM demultiplexer 830 receives the space superchannel 730 (FIG. 7B). The demultiplexer 830 provides at outputs separated spatial superchannels {λ₁₁, λ₁₂, λ₁₃, λ₁₄}, {λ₂₁, λ₂₂, λ₂₃, λ₂₄}, {λ₃₁, λ₃₂, λ₃₃, λ₃₄}, {λ₄₁, λ₄₂, λ₄₃, λ₄₄} corresponding to modes designated 1-4. A wavelength-selective K×K switch 840 is configured to provide at its outputs superchannels having a desired reconfigurable reordering of the wavelength channels among the separated spatial superchannels. Wavelength selective switches are described more fully in, e.g. N. K. Fontaine, et al., “N×M wavelength selective crossconnect with flexible passbands,” PDP5B.2, OFC/NFOEC (2012). In the illustrated embodiment the reordered superchannels are {λ₁₁, λ₂₂, λ₃₃, λ₄₄ }, {λ₃₄, λ₁₂, λ₂₃, λ₄₁}, {λ₂₄, λ₃₁, λ₄₂, λ₁₃}, {λ₁₄, λ₂₁, λ₃₂, λ₄₃}. Each of the latter three superchannels is wavelength-shifted by an instance of a wavelength shifter, 850a, 850b or 850c. The wavelength shifters 850 respectively provide wavelength shifts of Δλ, 2Δλ, 3Δλ such that the reordered superchannels do not overlap. A K×1 switch 860 combines the reordered superchannels to a produce combined space-wavelength superchannel exemplified by the signal 740 (FIG. 7B). In this manner the wavelength channels may be redirected to a desired space superchannel to implement a desired signal routing.

Those skilled in the pertinent art will appreciate that the embodiments of FIG. 7A/B and FIG. 8A/B are only two of many embodiments of conversion between space superchannels and wavelength superchannels.

Although multiple embodiments of the present invention have been illustrated in the accompanying drawings and described in the foregoing detailed description, it should be understood that the present invention is not limited to the disclosed embodiments, but is capable of numerous rearrangements, modifications and substitutions without departing from the invention as set forth and defined by the following claims.

1. An apparatus, comprising:
an input configured to receive an input optical signal;
an output configured to output an output optical signal;
a superchannel converter configured to convert N spatial modes of the input optical signal to M spatial modes of the output optical signal.

2. The apparatus of claim 1, wherein the superchannel converter is configured to convert an N-mode space superchannel to a wavelength superchannel that includes a corresponding plurality of wavelength channels.

3. The apparatus of claim 1, wherein the superchannel converter is configured to convert an N-mode space superchannel to an M-mode space/wavelength superchannel, wherein at least one mode of the M-mode space/wavelength superchannel includes a plurality of wavelength channels.

4. The apparatus of claim 2, wherein the wavelengths of the converted space/wavelength superchannel are mode-locked.

5. The apparatus of claim 1, wherein the superchannel converter is configured to perform optical-electrical-optical conversion of the input optical signal to the output optical signal.

6. The apparatus of claim 1, wherein the superchannel converter is configured to optically shift each of a plurality of the N spatial modes of the input optical signal from an input frequency to a corresponding output frequency.

7. The apparatus of claim 6, wherein the optical frequency shift is performed by four-wave mixing (FWM) or parametric amplification.

8. The apparatus of claim 1, wherein the superchannel converter is further configured to convert a plurality of wavelength channels of a spatial superchannel to a wavelength superchannel.

9. The apparatus of claim 8, wherein the wavelength channels have different center wavelengths.

10. The apparatus of claim 1, further comprising an input optical waveguide coupled to the input and an output optical waveguide coupled to the output.

11. A method, comprising:
configuring a superchannel converter to receive an input optical signal having N spatial modes and to output an optical signal having M spatial modes; and
configuring the superchannel converter to convert the N spatial modes of the input optical signal to the M spatial modes of the output optical signal.

12. The method of claim 11, further comprising configuring the superchannel converter to convert an N-mode space superchannel to a wavelength superchannel that includes a corresponding plurality of wavelength channels.

13. The method of claim 11, further comprising configuring the superchannel converter to convert an N-mode space superchannel to an M-mode space/wavelength superchannel, wherein at least one mode of the M-mode space/wavelength superchannel includes a plurality of wavelength channels.

14. The apparatus of claim 12, wherein the wavelengths of the converted space/wavelength superchannel are mode-locked.

15. The method of claim 11, further comprising configuring the superchannel converter to perform optical-electrical-optical conversion of the input superchannel to the output superchannel.

16. The method of claim 11, further comprising configuring the superchannel converter to optically shift each of a plurality of the N spatial modes of the input superchannel from an input frequency to a corresponding output frequency.

17. The method of claim 16, wherein a four-wave mixing (FWM) or parametric amplifier is configured to perform the optical frequency shift.

18. The method of claim 11, further comprising configuring the superchannel converter to convert a plurality of wavelength channels of a spatial superchannel to a wavelength superchannel.

19. The method of claim 18, wherein the wavelength channels have different center wavelengths.

20. The method of claim 11, further comprising coupling an input optical waveguide to the input and coupling an output optical waveguide to the output.
